(19) United States
(12) Patent Application Publication
(10) Pub. No.: US 2026/0133542 A1
(43) Pub. Date: May 14, 2026

(54) WATERPROOF TIMER

(71) Applicant: Time Timer LLC, Cincinnati, OH (US)

(72) Inventors: Tricia L. Wright, San Francisco, CA (US); David M. Rogers, Cincinnati, OH (US)

(21) Appl. No.: 19/441,142

(22) Filed: Jan. 6, 2026

Related U.S. Application Data
(63) Continuation-in-part of application No. 29/941,867, filed on May 13, 2024, now Pat. No. D1116862.

(51) Int. Cl. G04F 1/00

(52) U.S. Cl. CPC G04F 1/005

(57) ABSTRACT

A waterproof timer may used in a stand alone mode or a hanging mode inside a shower or kitchen. The timer has adjustable arms lockable in fixed positions using a ratchet mechanism. Each of the arms has a passage through which a cord may pass to hang the timer from a suction cup or a shower head. The time remaining assumes a numeric display inside a ring of graphic indicia. A battery powered LCD powers the display.

### CROSS REFERENCE TO RELATED APPLICATIONS

This application is a continuation-in-part of U.S. Design Patent Application No. 29/941,867 which is fully incorporated by reference herein.

### FIELD OF THE INVENTION

This invention relates generally to an apparatus and method for teaching time and, more particularly, to an apparatus and method of displaying remaining and elapsed time.

### BACKGROUND OF THE INVENTION

Numerous timers show elapsed and/or remaining time in a visual form. U.S. Pat. No. 7,773,464 discloses a timer which shows elapsed and/or remaining time as a portion of an annular ring and as a numeric read-out display. An annular ring of electronically generated graphic indicia are visible on a display face. A digital read-out display of remaining time is visible internally of the annular ring of graphic indicia. As time elapses, the annular ring of electronically generated indicia shrinks. The digital numerical display remains synchronized with the graphic indicia. The digital numerical display changes until the predetermined time has fully elapsed. The timer disclosed in U.S. Pat. No. 7,773,464 is not waterproof.

U.S. Pat. No. 6,636,458 discloses a waterproof kitchen timer which lacks the display of U.S. Pat. No. 7,773,464. However, it is not suitable for use in a shower.

Therefore, there is a need for a waterproof timer which may be hung and used in a shower.

There is further a need for a waterproof timer using an annular display which may be adjusted in height for use in a shower.

There is further a need for a visual timer using a liquid crystal display (LCD) which is waterproof.

### SUMMARY OF THE INVENTION

According to one aspect of the invention, a waterproof timer for displaying remaining and elapsed time comprises a housing having a rear portion and a front portion secured together. The rear portion of the housing has an interior inside which resides a rechargeable battery. The rear portion of the housing also has a recess with a USB port therein for charging the rechargeable battery.

The waterproof timer further comprises a control module inside an interior of the rear portion of the housing. The control module has an on/off button, a play/pause button, a PCB board, a speaker, multiple time adjustment buttons, an LCD display and multiple preset buttons. A first rubber seal covers an upper opening in the rear portion of the housing. The first rubber seal has multiple caps, each of the caps being above one of the preset buttons of the control module. A second rubber seal covers the recess with the USB port therein.

The waterproof timer further comprises an annular ring of electronically generated graphic indicia visible on the display face. The graphic indicia appear as a complete ring or an arcuate section of an annular ring of radially extending pixel bars on the display face. A digital numerical display is located inwardly from the annular ring of electronically generated graphic indicia. The digital numerical display is initially determined by which of the preset buttons is pushed.

The waterproof timer further comprises two adjustable arms pivotally secured to the housing. Each of the arms has a passage therethrough to enable a cord to pass through the passage. The play/pause button is for initiating progressive disappearing movement of the electronically generated graphic indicia to expose decreasing areas of the annular ring as time elapses until all graphic indicia disappears when the preset time has fully elapsed.

In a second aspect, a combination waterproof timer and cord may comprise the invention. The waterproof timer for displaying remaining and elapsed time comprises a rechargeable battery and a housing. The housing has a rear portion and a front cover secured together. The rear portion of the housing has a recess with a USB port therein and an upper opening.

The waterproof timer further comprises a control module. The control module has an on/off button, a play/pause button, a speaker, multiple time adjustment buttons, an LCD display and multiple preset buttons. A first rubber seal covers the upper opening in the rear portion of the housing. The first rubber seal has multiple caps, each of the caps being above one of the preset buttons of the control module. A second rubber seal covers the recess with the USB port therein.

The waterproof timer further comprises an annular ring of electronically generated graphic indicia visible on the display face. The graphic indicia appear as a complete ring or an arcuate section of an annular ring of radially extending pixel bars on the display face. A digital numerical display is located inwardly from the annular ring of electronically generated graphic indicia. The digital numerical display is initially determined by which of the preset buttons is pushed.

The waterproof timer further comprises two adjustable arms pivotally secured to the housing. Each of the arms has a passage therethrough to enable a cord to pass through the passage. The play/pause button is for initiating progressive disappearing movement of the electronically generated graphic indicia to expose decreasing areas of the annular ring as time elapses until all graphic indicia disappears when the preset time has fully elapsed. The cord is sized to fit through the passages of the adjustable arms of the waterproof timer.

In a third aspect, a waterproof timer for displaying remaining and elapsed time comprises a rechargeable battery and a housing having a recess with a USB port therein for charging the rechargeable battery.

The waterproof timer further comprises a control module inside an interior of the housing. The control module has an on/off button, a play/pause button, multiple time adjustment buttons, an LCD display and multiple preset buttons. A first rubber seal covers an upper opening in the rear portion of the housing. The first rubber seal has multiple caps, each of the caps being above one of the preset buttons of the control module. A second rubber seal covers the recess with the USB port therein.

The waterproof timer further comprises an annular ring of electronically generated graphic indicia visible on the display face. The graphic indicia appear as a complete ring or an arcuate section of an annular ring of radially extending pixel bars on the display face. A digital numerical display is located inwardly from the annular ring of electronically generated graphic indicia. The digital numerical display is initially determined by which of the preset buttons is pushed.

The waterproof timer further comprises two adjustable arms pivotally secured to the housing. Each of the arms has a passage therethrough to enable a cord to pass through the passage. The play/pause button is for initiating progressive disappearing movement of the electronically generated graphic indicia to expose decreasing areas of the annular ring as time elapses until all graphic indicia disappears when the preset time has fully elapsed.

The accompanying drawings, which are incorporated in and constitute a part of this specification, illustrate embodiments of the invention and, together with the summary of the invention given above, and the detailed description of the drawings given below, explain the principles of the present invention.

### BRIEF DESCRIPTION OF THE DRAWINGS

FIG. 1 is a front perspective view of a waterproof timer.

FIG. 2 is a front disassembled view of the waterproof timer of FIG. 1.

FIG. 2A is a rear disassembled view of the waterproof timer of FIG. 1.

FIG. 3 is a front view of the waterproof timer of FIG. 1 hanging from a support with a cord in a lowered position.

FIG. 4 is a front view of the waterproof timer of FIG. 1 hanging from a support with a cord in a raised position.

FIG. 5 is an enlarged front view of the waterproof timer of FIG. 1.

FIG. 6 is a side view of the waterproof timer of FIG. 1.

FIG. 7 is a rear view of the waterproof timer of FIG. 1.

FIG. 8 is a side view of a portion of the waterproof timer of FIG. 1 showing one of the arms locked in a vertical position.

FIG. 9 is a side view of the waterproof timer of FIG. 1 showing one of the arms locked in a vertical position.

FIG. 10A is a side view of the waterproof timer of FIG. 1 showing the arms in their vertical raised position.

FIG. 10B is a side view of the waterproof timer of FIG. 1 showing the arms in their second position.

FIG. 10C is a side view of the waterproof timer of FIG. 1 showing the arms in their third position.

FIG. 10D is a side view of the waterproof timer of FIG. 1 showing the arms in their fourth position.

### DETAILED DESCRIPTION OF THE INVENTION

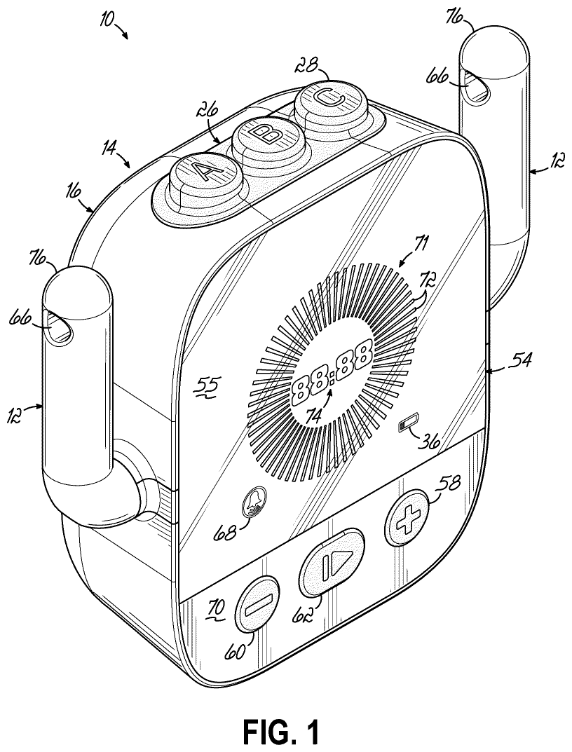

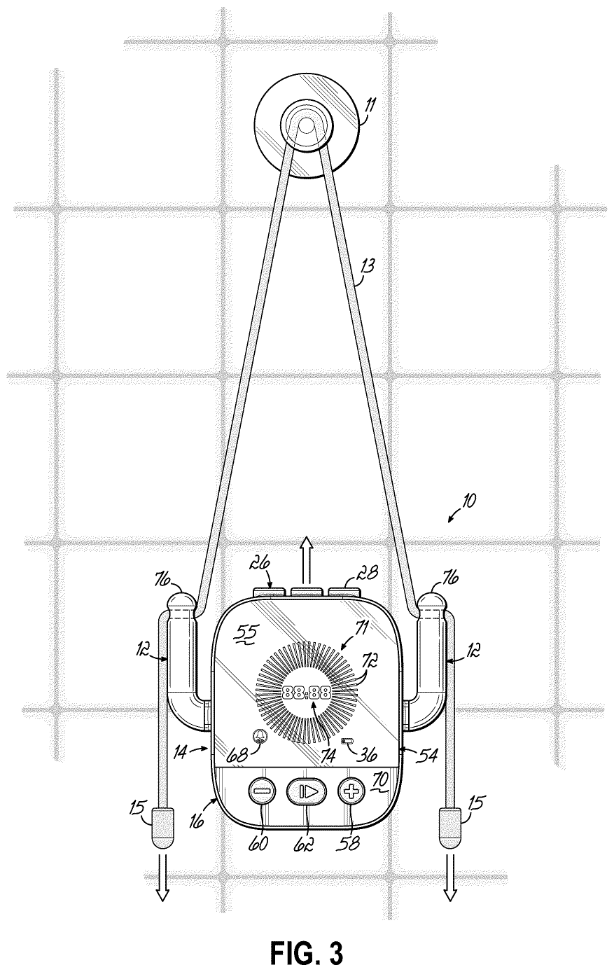

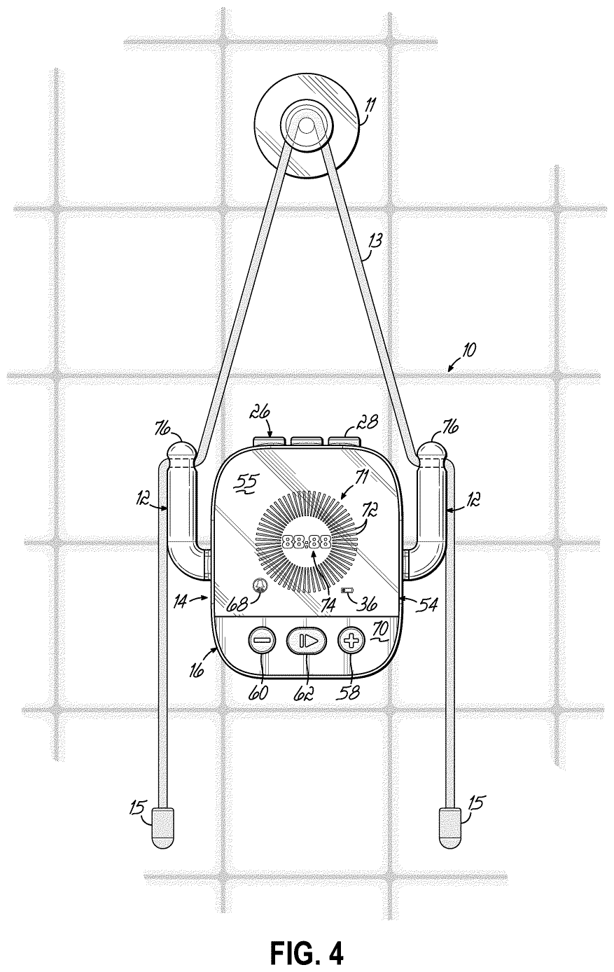

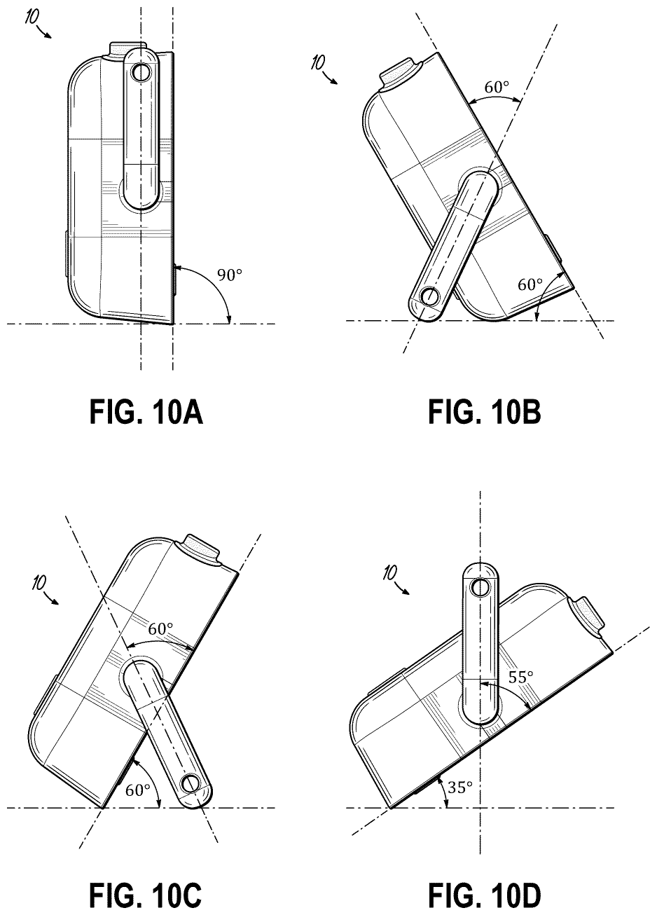

Referring first to FIG. 1, there is illustrated a waterproof timer 10 having two moveable arms 12 which may be locked in predetermined positions shown in FIGS. 10A-10D. The waterproof timer 10 may be used on a flat surface as shown in FIGS. 10A-10D or hung using a suction cup 11 and a cord 13, as shown in FIGS. 3 and 4. As shown in FIGS. 3 and 4, the cord 13 has a protrusions 15 at each end which may not pass through passages 66 in the arms 12. These protrusions 15 may be integral with the cord 13 or attached thereto. The cord 13 is sized to have a friction fit inside the passages 66 in the arms as shown in FIGS. 3 and 4.

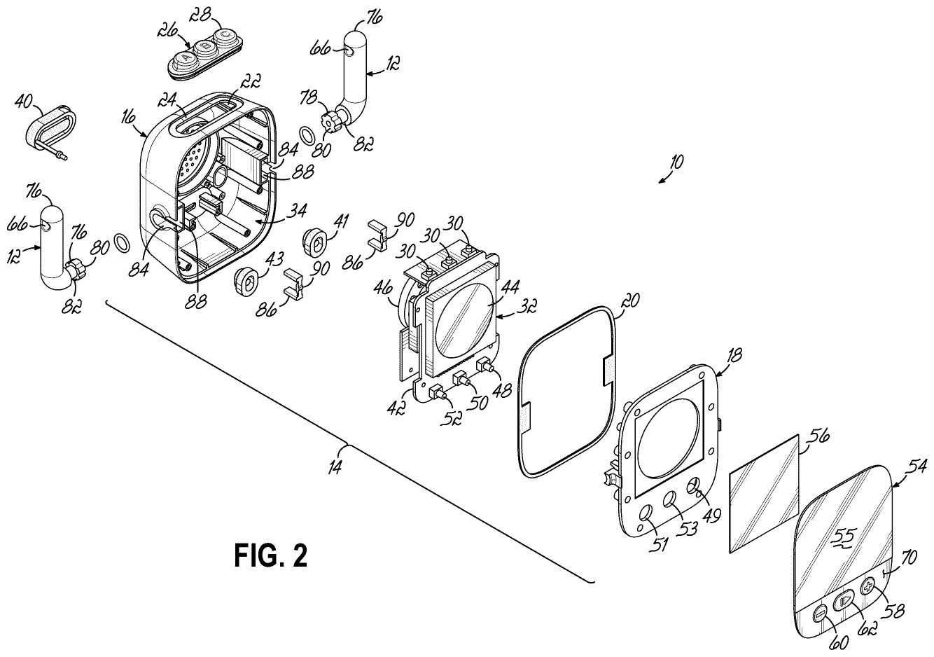

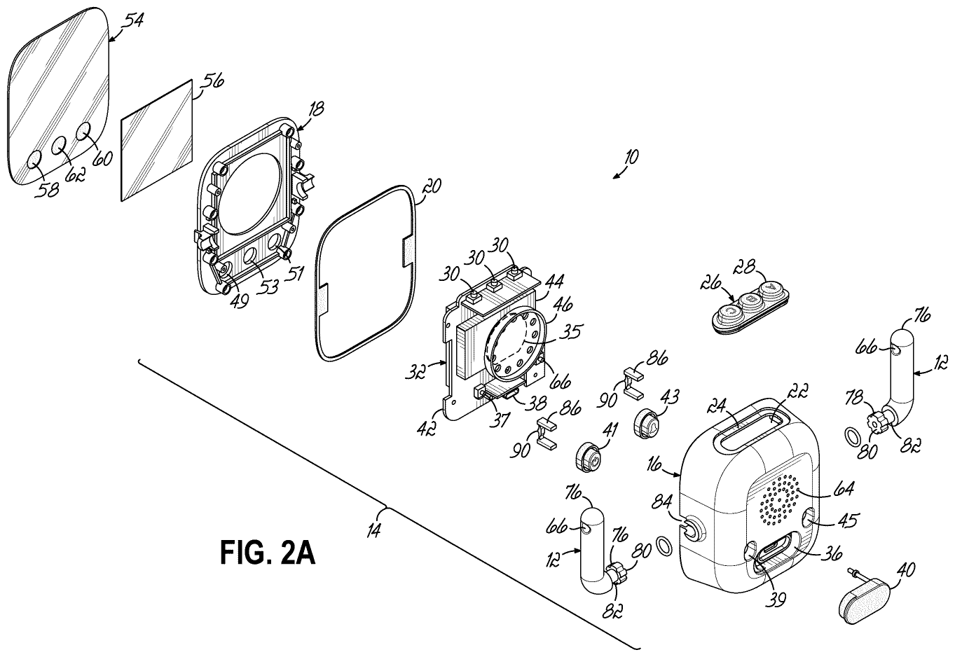

As best shown in FIGS. 2 and 2A, the waterproof timer 10 has a housing 14 having a rear portion 16 and a front portion 18 between which is a rubber gasket 20. As shown in FIG. 2, the rear portion 16 of housing 14 has an oval shaped upper opening 22 with a sunken perimeter 24 adapted to receive a first rubber seal 26. The first rubber seal 26 is a unitary piece having three circular caps 28 labelled A, B and C which are adapted to cover three preset buttons 30 of a control module 32. Each raised cap 28 is adapted to cover one of the preset buttons 30 underneath the raised cap 28. Although the drawings show icons A, B and C on the tops of the raised caps 28, any other symbol or icon may be used.

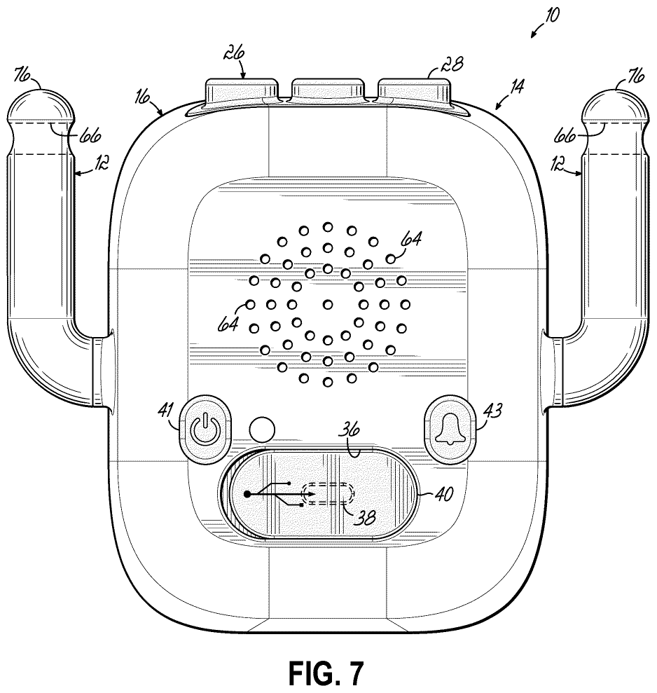

As shown in FIG. 2, the rear portion 16 of housing 14 has an interior 34. As best shown in FIGS. 2, 2A and 7, the rear portion 16 of housing 14 has a charging port recess 36 inside which is a USB-C charging port 38. A rubber charging port cover 40 is removable to expose the charging port 38.

To recharge the lithium-ion battery 35, the rubber charging port cover 40 is removed to expose the charging port 38. A USB-C portion of a charging cable (not shown) is plugged into the charging port 38. The other end of the charging cable having a USB-A port is plugged into a charging block or power source. When charging is complete, the charging cable is removed and the rubber charging port cover 40 is returned to its original position.

As best shown in FIGS. 2 and 2A, the waterproof timer 10 further comprises a control module 32 which includes a PCB Board 42 to which is attached a LCD display 44 and a speaker 46. As shown in FIG. 7, the rear portion 16 of housing 14 has holes 64 to allow sound waves from the speaker 46 to pass out the back of the housing 14.

As shown in FIG. 2A, the waterproof timer 10 further comprises a rechargeable lithium-ion battery 35. When the battery charge is below a certain percentage, a battery icon 36, shown in FIG. 1, is illuminated.

As best shown in FIG. 2A, the control module 32 further comprises an on/off button 37 which extends through an opening 39 in the rear portion 16 of housing 14. A rubber cover 41 fits into the opening 39. In order to start the timer, a user pushes on the rubber cover 41 which activates the on/off button 37.

As best shown in FIG. 2, the control module 32 further comprises three adjustment buttons including a plus button 48, a negative button 52 and a play/pause button 50. These adjustment buttons are below the LCD display 44. The plus button 48 extends through an opening 49 in the front portion 18 of housing 14 and is activated by a user pushing an icon 58 at the bottom portion 70 of a front film 54. Activation of the plus button 48 adds time onto one of the preset times. In one embodiment, pushing the plus button 48 once adds one second to the set time. By holding the plus button 48 down, ten seconds may be added to the set time. Any desired time may be added to an initial preset time.

The front film 54 is secured to a front surface of the front portion 18 of housing 14. The negative button 52 extends through an opening 51 in the front portion 18 of housing 14 and is activated by a user pushing an icon 60 at the bottom portion 70 of the front film 54. Activation of the negative button 52 subtracts time from a preset time. In one embodiment, pushing the negative button 52 once subtracts one second from the set time. By holding the negative button 52 down, ten seconds may be subtracted from the set time. Any desired time may be subtracted from an initial preset time.

Lastly, the play/pause button 50 extends through an opening 53 in the front portion 18 of housing 14 and is activated by a user pushing an icon 62 at the bottom portion 70 of the front film 54. Activation of the play/pause button 50 starts the timer 10 or may pause the timer 10.

As shown in FIGS. 2 and 7, the waterproof timer 10 further comprises a LCD display cover 56, an on/off power button cover 41 and a volume button cover 43. The volume button cover 43 extends through an opening 45 in the rear portion 16 of housing 14. The volume may be switched between the off, low volume and high volume positions. The state of the volume setting is indicated by a volume indicator 68 shown in FIG. 1.

In one preferred embodiment, when the preset button 30 underneath the cap 28 having the A letter is pushed, the timer is preset to two minutes. When the preset button 30 underneath the cap 28 having the B letter is pushed, the timer is preset to eight minutes. When the preset button 30 underneath the cap 28 having the C letter is pushed, the timer is preset to 25 minutes. These preset time periods may be changed as desired by activating one of the positive and negative buttons 48, 50, respectively. These preset numbers may be other time periods in other embodiments.

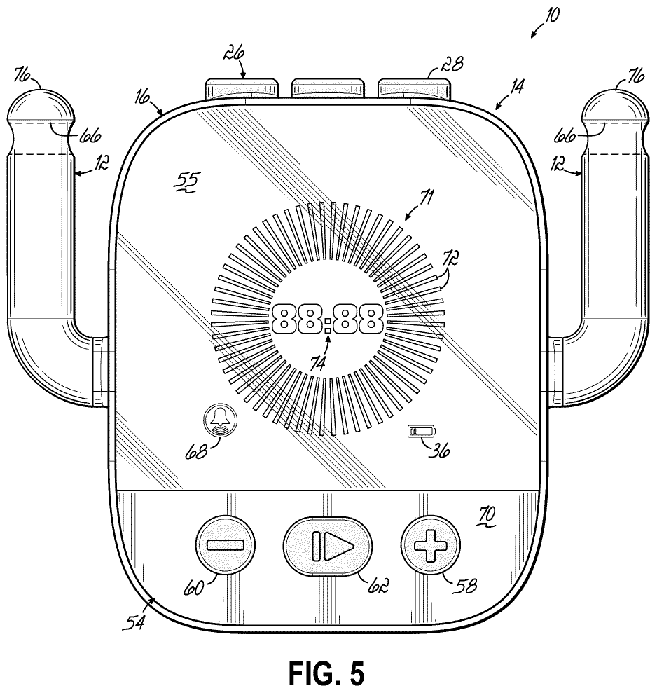

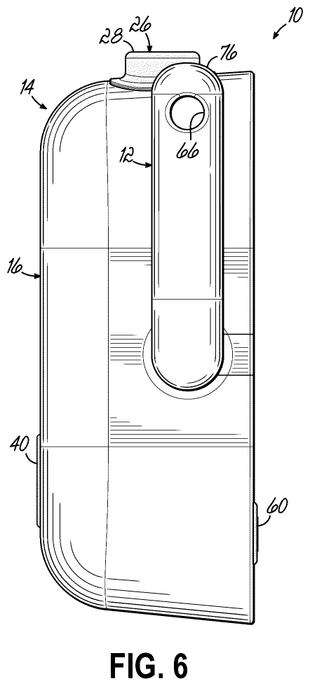

As shown in FIGS. 1 and 5, the waterproof timer 10 further comprises an annular ring 71 of electronically generated graphical indicia 72 in the form of triangles or pixel bars visible on the display face 55. A digital numerical display 74 is located inside the annular ring 71 of electronically generated graphical indicia 72. The initial digital numerical display 74 is determined by which of the preset buttons is activated or pushed. As time elapses, the number of visible triangles or pixel bars 72 visible on the display face 55 decreases and the digital numerical 74 changes to correspond with the number of visible triangles or pixel bars 72 visible on the display face 55.

Each of the adjustable arms 12 has a passage 66 therethrough at a distal end 76 thereof. The passages 66 are aligned with each other when the adjustable arms 12 are in the same position. The passages 66 are sized to allow a cord 13 to pass therethrough.

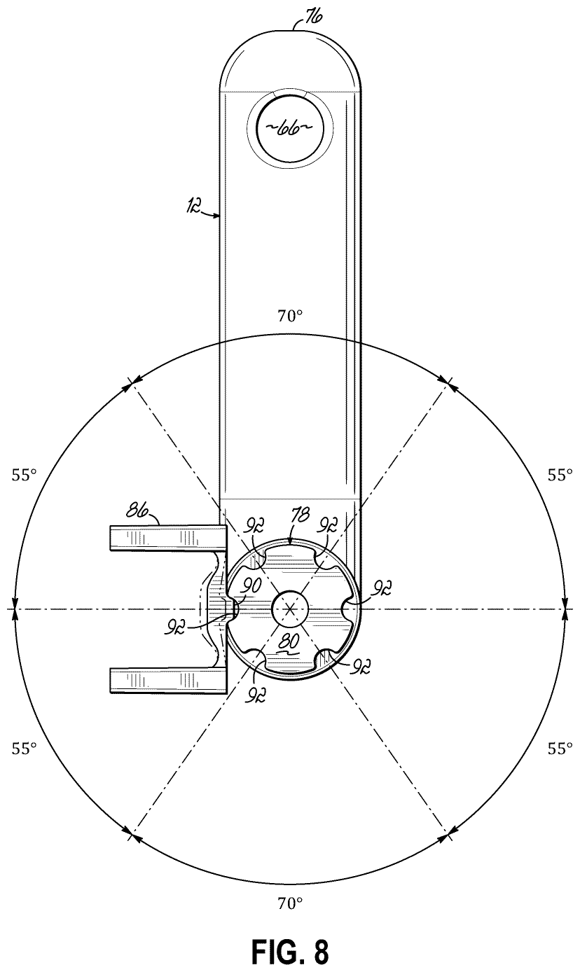

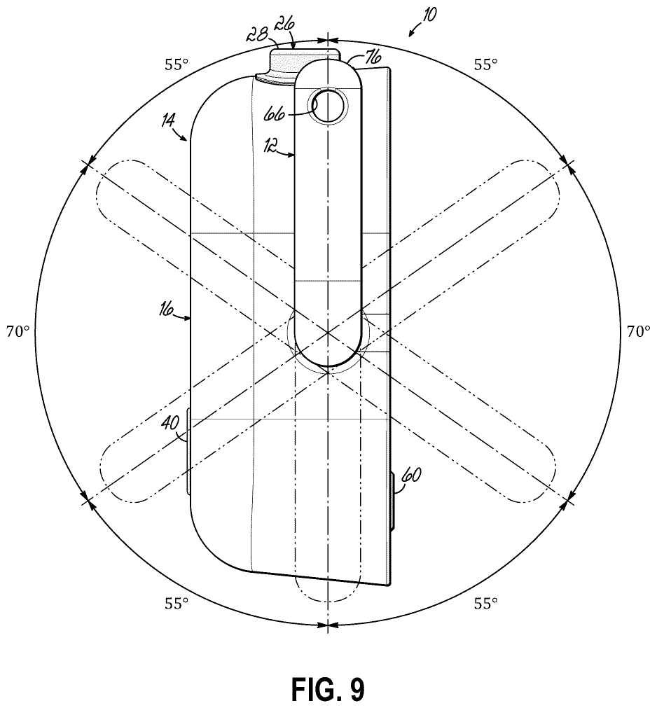

Each of the adjustable arms 12 is preferable a unitary member having a ratchet portion 78 at a proximal end 80 thereof. The ratchet portion 78 has a plurality of spaced detents 92. A narrow ring 82 is located inside the ratchet portion 78 of each adjustable arm 12. The narrow ring 82 fits through one of the slots 84 extending through the rear portion 16 of housing 14. An arm encasement 86 having a C-shape with a stop 90 is located in a cavity 88 in the rear portion 16 of housing 14. As best shown in FIG. 8, the stop 90 engages one of the detents 92 of the ratchet portion 78 to hold the adjustable arm 12 in a desired position, as shown in FIGS. 10A-10D.

The various embodiments of the invention shown and described are merely for illustrative purposes only, as the drawings and the description are not intended to restrict or limit in any way the scope of the claims. Those skilled in the art will appreciate various changes, modifications, and improvements which can be made to the invention without departing from the spirit or scope thereof. The invention in its broader aspects is therefore not limited to the specific details and representative apparatus and methods shown and described. Departures may therefore be made from such details without departing from the spirit or scope of the general inventive concept. For example, the faces of the boards may show different time periods than those illustrated. The invention resides in each individual feature described herein, alone, and in all combinations of any and all of those features. Accordingly, the scope of the invention shall be limited only by the following claims and their equivalents.

What is claimed is:

1. A waterproof timer for displaying remaining and elapsed time comprising:
a housing having a rear portion and a front portion secured together, the rear portion of the housing having an interior inside which resides a rechargeable battery, the rear portion of the housing having a recess with a USB port therein for charging the rechargeable battery;
a control module inside an interior of the rear portion of the housing, the control module having and on/off button, a play/pause button, a PCB board, a speaker, multiple time adjustment buttons, an LCD display and multiple preset buttons;
a first rubber seal covering an upper opening in the rear portion of the housing, the rubber seal having multiple caps, each of the caps being above one of the preset buttons of the control module,
a second rubber seal covering said recess with the USB port therein;
an annular ring of electronically generated graphic indicia visible on the display face, which graphic indicia appear as a complete ring or an arcuate section of an annular ring of radially extending pixel bars on the display face;
a digital numerical display located inwardly from the annular ring of electronically generated graphic indicia, the digital numerical display being initially determined by which of the preset buttons is pushed;
two adjustable arms pivotally secured to the housing, each arm having a passage therethrough to enable a cord to pass through the passage,
wherein the play/pause button is for initiating progressive disappearing movement of the electronically generated graphic indicia to expose decreasing areas of the annular ring as time elapses until all graphic indicia disappears when the whole of the set time has fully elapsed.

2. The waterproof timer of claim 1, wherein the arms may be set in predetermined positions.

3. The waterproof timer of claim 1, wherein the rechargeable battery is a lithium-ion battery.

4. The waterproof timer of claim 1, wherein each of the arms has a ratchet portion for engaging a stop.

5. The waterproof timer of claim 1, further comprising an on/off momentary sound button.

6. The waterproof timer of claim 1, wherein icons on top of the caps correlate with predetermined times.

7. The waterproof timer of claim 1, further comprising a cord sized to fit through the arms.

8. A combination waterproof timer and cord, the combination comprising:
a waterproof timer for displaying remaining and elapsed time, the waterproof timer comprising:
a rechargeable battery;
a housing, the housing having a rear portion and a front cover secured together, the rear portion of the housing having a recess with a USB port therein, and an upper opening;
a control module having an on/off button, a play/pause button, a speaker, multiple time adjustment buttons, an LCD display and multiple preset buttons;
a first rubber seal covering the upper opening in the rear portion of the housing, the rubber seal having multiple caps, each of the caps being above one of the preset buttons of the control module,
a second rubber seal covering said recess with the USB port therein;
an annular ring of electronically generated graphic indicia visible on the display face, which graphic indicia appear as a complete ring or an arcuate section of an annular ring of radially extending pixel bars on the display face;
a digital numerical display located inwardly from the annular ring of electronically generated graphic indicia, the digital numerical display being initially determined by which of the preset buttons are pushed;
two adjustable arms pivotally secured to the housing, each arm having a passage therethrough to allow a cord to pass through the arm,
wherein the play/pause button is for initiating progressive clockwise disappearing movement of the electronically generated graphic indicia to expose decreasing areas of the annular ring as time elapses until all graphic indicia disappears when the preset time has fully elapsed; and
a cord sized to fit through the arms of the waterproof timer.

9. The combination of claim 8, further comprising a suction cup.

10. The combination of claim 8, wherein the arms may be set in predetermined positions.

11. The combination of claim 8, further comprising an on/off momentary sound button.

12. The combination of claim 8, wherein icons on top of the caps correlate with predetermined times.

13. The combination of claim 8, further comprising at least one lithium-ion battery inside the interior of the housing.

14. A waterproof timer for displaying remaining and elapsed time comprising:
a rechargeable battery;
a housing having a recess with a USB port therein for recharging the rechargeable battery and an upper opening;
a control module inside an interior of the housing, the control module having an on/off button, a play/pause button, multiple time adjustment buttons, an LCD display and multiple preset buttons;
a first rubber seal covering said upper opening in the housing, the first rubber seal being above the preset buttons of the control module,
a second rubber seal covering said recess with the USB port therein;
an annular ring of electronically generated graphic indicia visible on a display face, which graphic indicia appear as a complete ring or an arcuate section of an annular ring of radially extending pixel bars on the display face;
a digital numerical display located inwardly from the annular ring of electronically generated graphic indicia, the digital numerical display being determined by which of the preset buttons are pushed;
two adjustable arms, each arm having a passage therethrough to secure a cord with a friction fit,
wherein the play/pause button initiats progressive disappearing movement of the electronically generated graphic indicia to expose decreasing areas of the annular ring as time elapses until all graphic indicia disappears when the preset time has fully elapsed.

15. The waterproof timer of claim 14, wherein each of the adjustable arms has a ratchet portion at an end thereof and a stop engaged with the ratchet portion.

16. The waterproof timer of claim 14, wherein the arms may be set in predetermined positions.

17. The waterproof timer of claim 14, wherein each of the arms has a rachet portion at the end thereof.

18. The waterproof timer of claim 14, wherein each of the arms is a unitary member.

19. The waterproof timer of claim 14, further comprising a battery icon for displaying a low battery.

20. The waterproof timer of claim 14, further comprising a sound icon for displaying a desired amount of sound.
